(19) United States
(12) Patent Application Publication
(10) Pub. No.: US 2009/0272802 A1
(43) Pub. Date: Nov. 5, 2009

(54) PAYMENT TRANSACTIONS INITIATED VIA A USER'S SHOE

(76) Inventor: Simon Phillips, York (GB)

Correspondence Address: BUCKLEY, MASCHOFF & TALWALKAR LLC, 50 LOCUST AVENUE, NEW CANAAN, CT, 06840, US

(21) Appl. No.: 12/113,405

(22) Filed: May 1, 2008

(51) Int. Cl. G07B 15/02

(52) U.S. Cl. 235/384

(57) ABSTRACT

A method includes wearing a shoe on a user's foot. The shoe incorporates a proximity payment device. The method also includes bringing the shoe into proximity with a proximity reader to make or evidence a payment.

### BACKGROUND

Proximity payment devices are well-known. For example, card-shaped proximity payment devices (sometimes referred to as “contactless payment cards”) incorporate a radio frequency identification (RFID) integrated circuit (IC) and an antenna. Such devices may be used in place of a conventional magnetic stripe credit or debit card to pay for purchase transactions. In operation, the device is tapped on a proximity reader component of a POS terminal. When this occurs, the RFID IC receives an interrogation signal from the proximity reader and uploads the user's payment card account number to the POS terminal through the proximity reader via wireless RF signaling.

MasterCard International Incorporated, the assignee hereof, has established a widely-used standard, known as “PayPass”, for interoperability of contactless payment cards and proximity readers.

It has also been proposed to provide proximity payment devices in form factors that are not card-shaped. Keyfob proximity payment devices have been proposed, and it has also been proposed to incorporate proximity payment capabilities in wristwatches, mobile telephones, etc.

Proximity payment devices often provide enhanced convenience in carrying out transactions, as compared to conventional magnetic stripe payment cards. However, the present inventor has observed that it may be desirable to aspire to still greater convenience. For example, payment transactions may entail awkward fumbling and delay, in removing a proximity payment card or payment-enabled mobile telephone from a pocket, purse or wallet, when an individual is in a hurry, and/or is encumbered with packages, an umbrella, a handbag, etc.

### BRIEF DESCRIPTION OF THE DRAWINGS

FIG. 1 schematically illustrates incorporation of proximity payment capabilities into a shoe.

FIG. 2 is a schematic plan view of a proximity payment component shown in FIG. 1.

FIG. 3 is a schematic view showing an entrance to a transit system provided in accordance with aspects of the present invention.

FIG. 4 is a block diagram representation of the transit system entrance of FIG. 3.

FIG. 5 is a schematic representation of another embodiment of a transit system entrance.

FIG. 6 is a flow chart that illustrates a process that may be performed to use a payment-enabled shoe in accordance with the invention.

### DETAILED DESCRIPTION

In general, and for the purpose of introducing concepts of embodiments of the present invention, active components for a proximity payment device are incorporated in a shoe. The wearer of the shoe is able to make or evidence payments by walking over or standing on a proximity reader. In one preferred application of this concept, a shoe that functions as a proximity payment device is used to gain access to a transit system.

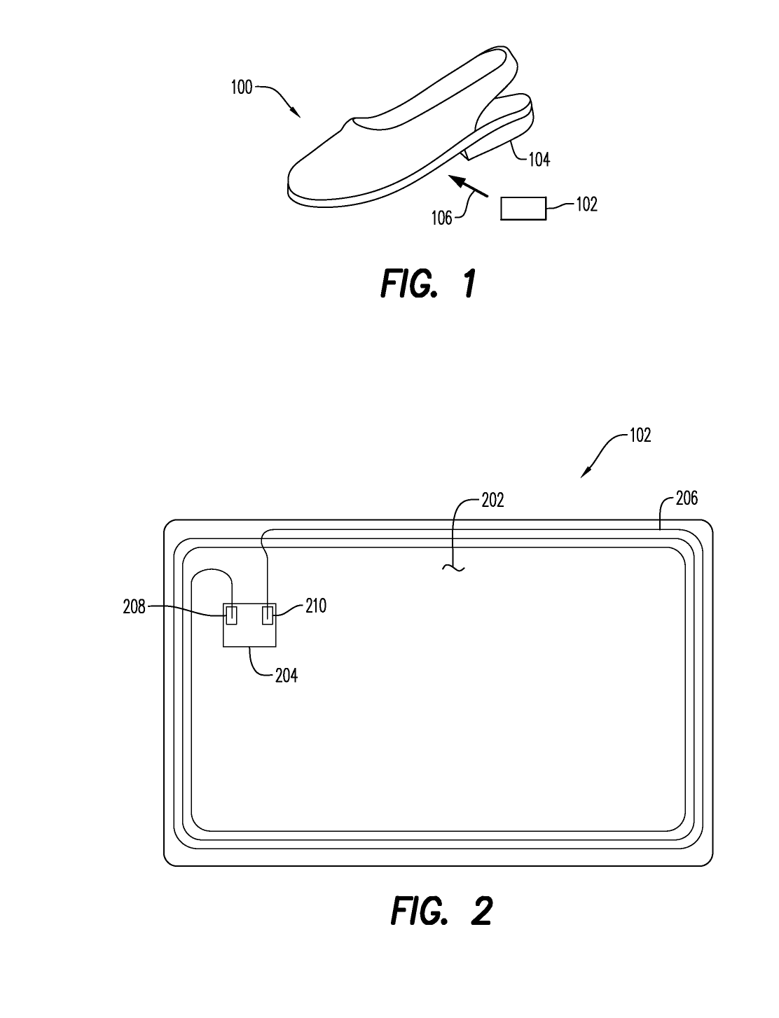

FIG. 1 schematically illustrates incorporation of proximity payment capabilities into a shoe 100. In particular, a proximity payment module 102 may be secured by any one of a number of ways on or in the shoe 100. For example, the proximity payment module may be glued to the sole of the shoe 100 in a recessed part of the sole that is just ahead of the heel 104 of the shoe 100.

In another embodiment, and consistent with teachings of co-pending and commonly-assigned patent application Ser. No. 11/829,165 (filed Jul. 27, 2007 and incorporated herein by reference), a label having a pouch may be adhered to the shoe (on its sole or elsewhere) and the proximity payment module may be inserted in the pouch of the label. Such an arrangement may be advantageous in that the proximity payment module may be readily removed from the pouch of the label, replaced with another proximity payment module (by inserting the other proximity payment module in the pouch), etc.

In still another embodiment, the shoe may be manufactured with a slot that is shaped and sized to receive a proximity payment module, and the proximity payment module may be removably/replaceably inserted in the slot. In still other embodiments, once the proximity payment module is inserted in such a slot, glue or the like may be applied to permanently secure the proximity payment module in the slot, thereby permanently affixing the proximity payment module to the shoe.

In another type of embodiment, the proximity payment module may be permanently embedded in the shoe (e.g., between inner and outer soles of the shoe) during the process of manufacturing the shoe.

The arrow mark 106 in FIG. 1 represents any one or more of these processes for securing the proximity payment module in or to the shoe. Other manners of securing the proximity payment module to the shoe are possible and will be recognized by those who are skilled in the art.

FIG. 2 is a schematic plan view of the proximity payment module 102.

The proximity payment module 102 may include a card-shaped body 202. The proximity payment module 102 may have substantially the same form factor, for example, as a conventional SIM card for a mobile telephone, and thus the card-shaped body 202 may be shaped and sized to resemble a SIM card. The card-shaped body 202 may be formed of plastic or another suitable material. (The drawing is not necessarily to scale.)

The proximity payment module 102 may also include an RFID IC 204. The RFID IC 204 may be mounted and/or installed in any suitable manner in the card-shaped body 202. The RFID IC 204 may be similar to RFID ICs that are employed in contactless payment cards. For example, the RFID IC 204 may be designed and configured to operate in accordance with the “PayPass” standard promulgated by MasterCard International Incorporated, the assignee hereof Accordingly, the RFID IC 204 may store an account number and/or other information to be used in initiating a payment in connection with a purchase transaction. In other embodiments, the RFID IC 204 may include a number that uniquely identifies the RFID IC 204/proximity payment module 102 for the purpose of allowing the proximity payment module 102 to serve as an access/payment token for a transit system. For example, the RFID IC 204 may store information of the type used in transit systems to properly identify a monthly transit access card. The RFID IC may be configured/programmed to interact with a proximity reader employed to control access to a transit system.

The proximity payment module 102 may further include an antenna 206 embedded or otherwise mounted on the card-shaped body 202. As shown, the antenna 206 may be in the form of several loops arranged along the periphery of the card-shaped body. Alternatively, the antenna 206 may be of a different type and/or configuration.

Returning to the RFID IC 204, it will be noted that it includes electrically conductive contact pads 208, 210, by which the RFID IC 204 is electrically conductively connected to the antenna 206.

In some embodiments, the proximity payment module may be used to charge transactions to a payment account that is identified by, and/or linked to, a number that is stored in the RFID IC 204. In addition or alternatively, the proximity payment module may be used to provide a signal or signals that confirm that the user has pre-paid for some privilege, such as access to a transit system for a pre-determined period of time such as a calendar month or week. Thus, the proximity payment module may be used to evidence payment in addition to or as an alternative to making a payment.

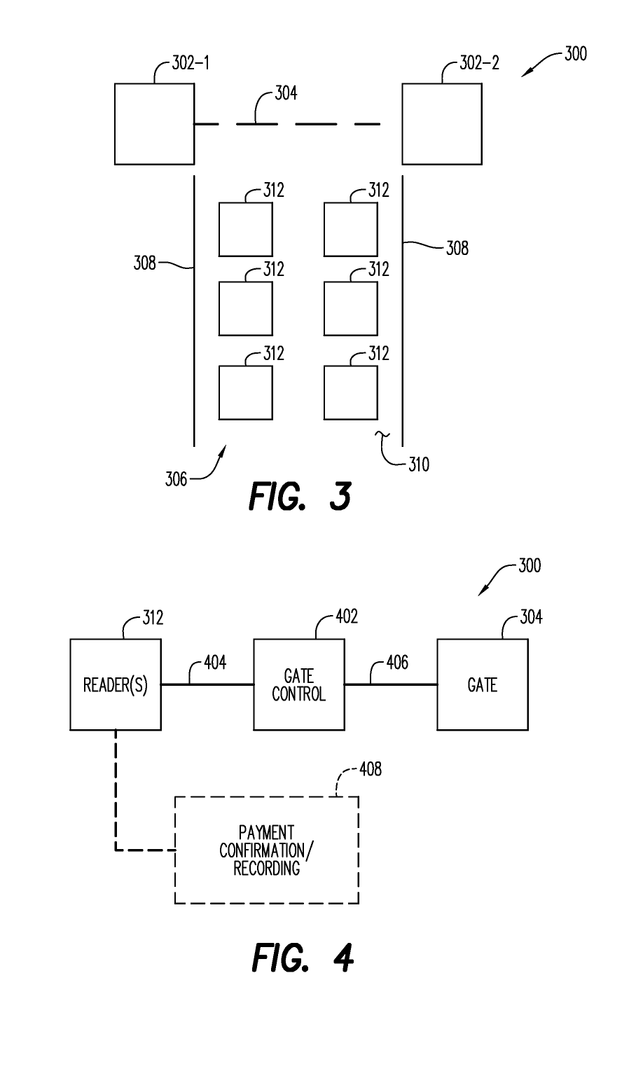

FIG. 3 is a schematic plan view showing an entrance 300 to a transit system (not separately shown), where the entrance 300 is configured in accordance with aspects of the present invention.

For present purposes, it is assumed that the entrance 300 is at least partially defined by gate posts 302-1 and 302-2 that are installed at either side of the entrance 300. One of the gate posts (in this example, gate post 302-1) may support a gate or turnstile that is schematically illustrated at 304. The gate 304 selectively obstructs the entrance 300 to prevent unauthorized passage therethrough. A pathway 306 to the entrance 300 is defined by rails or guides 308 (which may in some embodiments merely be lines drawn on the floor 310).

FIG. 3 also shows a number of proximity readers 312 which may be installed along the pathway 306 and beneath the floor 310. The proximity readers 312 may be configured to read data from proximity payment modules that are affixed to the shoes of individuals who walk down the pathway 306 toward the entrance 300.

FIG. 4 is a block diagram representation of the transit system entrance 300. FIG. 4 shows the above-mentioned proximity readers 312 and gate 304. In addition, FIG. 4 shows a gate control circuit 402 coupled by a signal path 404 to the proximity readers 312, and also operatively coupled (as indicated at 406) to the gate 304. In some embodiments, the proximity readers 312 may also be coupled to a central database/computer 408 which may check the validity of data presented to the proximity readers 312 by the proximity payment modules. In addition or alternatively, the central database/computer 408 may record payment transactions initiated for access to the transit system by the proximity payment modules read by the proximity readers 312.

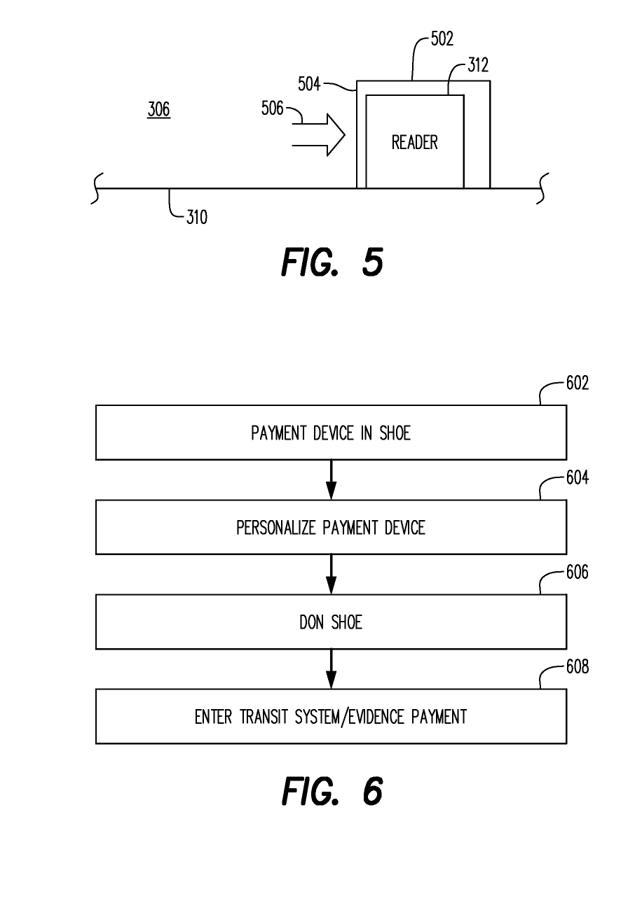

In the arrangement shown in FIG. 3, the proximity payment modules are installed beneath the floor along the pathway that leads to the transit system entrance. An alternative arrangement is shown in FIG. 5. In FIG. 5, a proximity reader 312 is installed in a housing 502. The housing 502 is adjacent to, and extends above, the floor 310. In particular, the housing 502 presents toward the pathway 306 a vertical surface 504 that is joined to the floor 300. The proximity reader 312 is immediately behind the vertical surface 504 and is adjacent to the level of the floor 300. (For example, the proximity reader may be less than 12 inches above the floor.) If an individual is wearing a shoe that includes a proximity payment module, and wishes the module to be read by the proximity reader 312, he/she may tap his/her shoe on the vertical surface 504 as indicated at 506 in FIG. 5. This tapping may be in a horizontal direction.

The configuration of the proximity reader 312 and of the proximity payment module may be such that the proximity reader is able to read a proximity payment module only when the shoe to which the module is attached is tapped in the manner referred to in the previous paragraph. This may tend to prevent unauthorized or inadvertent reading of the proximity payment module. To aid in such an arrangement, the proximity payment module may be secured to a side of the shoe rather than elsewhere on the shoe.

FIG. 6 is a flow chart that illustrates a process that may be performed to use a payment-enabled shoe in accordance with the invention.

In the process of FIG. 6, as indicated at 602, the proximity payment module is in some manner affixed to or incorporated in the user's shoe, as described above. At 604, the proximity payment module is “personalized” in the sense of loading the module with specific data that either uniquely identifies the module, or at least renders it operable for its intended purpose. This may be done, for instance, by bringing a suitably programmed contactless smart card into proximity with the proximity payment module, in a manner consistent with the teachings of co-pending, commonly assigned patent application Ser. No. 11/870,144, filed Oct. 10, 2007 (which is incorporated herein by reference). In other embodiments, a mobile telephone may be suitable equipped and programmed to personalize the proximity payment module. Alternatively, the proximity payment module may have been personalized prior to its being incorporated in the user's shoe.

The data loaded into the module during personalization, whenever performed, may include an identifier number or character string that uniquely identifies the module. Such an identifier may be referred to as a token identifier.

At 606, the user puts the shoe, with the proximity payment module incorporated therein, on his/her foot. Then, at 608 the user travels (e.g., walks) to the transit system and enters the transit system via an entrance such as that depicted in FIG. 3. As the user approaches the entrance, the proximity payment module in or on his/her shoe is read by a proximity reader 312. The reader 312 forwards information read from the proximity payment module to the gate control circuit 402, or otherwise provides a suitable signal to the gate control circuit 402. In response to the signal from the reader 312, the gate control circuit 402 causes the gate 304 to open, thereby admitting the user to the transit system.

In some embodiments, the reader 312 may read an account number from the proximity payment module, and may relay the account number to the database/computer 408 to cause a suitable transit access fare to be charged to the user's account. In addition or alternatively, the database/computer 408 may check the validity of the account number and/or the validity of the proximity payment module, and may send a signal confirming validity to the reader 312. In some embodiments, the reader signals the gate control circuit to open the gate only after validity of the account number and/or the proximity payment module is confirmed by the database/computer 408.

In other embodiments, the proximity payment module may be used to evidence payment of a monthly or weekly fare or the like. For example, the proximity payment module may be loaded with a code that indicates that the proximity payment module is valid for access to the transit system for the next month. Upon reading the code from the proximity payment module, the reader 312 recognizes that the proximity payment module is valid, and instructs the gate control circuit to open the gate. In this sort of arrangement, for example, the proximity payment module may be loaded each month with the next month's code. This may occur via interaction with a smart card, as mentioned above in connection with 604 in FIG. 6. In some embodiments, to protect the revenue security of the system, the proximity payment module may cryptographically combine the code with a module identification number, and possibly also with a date/time stamp, and then may transmit the result of the cryptographic calculation to the reader.

In other embodiments, the proximity payment module may operate as a stored value device, and may be decremented for the transit access fare in connection with being read by the reader 312.

In some embodiments, the transit system fare scheme may require that the system track the users' points of exit from the system as well as points of entry. In such cases, proximity readers may be installed at exits of the transit system as well as at entrances.

In some embodiments, the pathway to the entrance may be defined, and the reader(s) may be located relative to the pathway, such that the gate is opened, in response to reading the proximity payment device, at a timing that opens the gate just as the user reaches the gate, rather than requiring the user to wait at the gate for it to be opened. This may speed users' entrance into the transit system.

While shoe-based proximity payment transactions have up to this point been described primarily in connection with access to a transit system, other applications are possible, including in connection with purchase transactions at retail stores, etc. In the latter cases, the payment transactions via a proximity payment module in one's shoe may be more convenient and/or more rapid that conventional proximity payment via a card that is normally kept in the user's wallet or purse. Shoe-based proximity payment may also reduce the possibility of leaving the proximity payment device behind at the store.

In some retail applications, a pad or a similar object is installed on the floor next to the POS terminal, and includes a proximity reader for reading the proximity payment device in a shoe with which the customer steps on the pad. To authenticate the transaction, the customer may also be required to enter a personal identification number (PIN) into a peripheral device connected to the POS terminal. In addition or alternatively, authentication at the POS terminal may require the customer to submit biometric identification, by (e.g.) presenting his/her thumb or finger to a fingerprint reader component of the POS terminal. With this second-factor security requirement, the customer may enjoy the convenience of not having to remove a payment card from wallet or purse, while being protected against theft of the customer' shoe/payment device or misuse of the payment account information.

In some embodiments, the proximity payment module may operate by transmitting “dynamic data”. That is, the proximity payment module may cryptographically modify the account number that it stores before transmitting the result to the reader, and the cryptographic modification of the account number may be performed in such a way that the encrypted account number information is different with each reading of the proximity payment module. It is then up to the payment system to reverse the cryptographic calculation so as to recover the actual account number. This may help protect the payment system against unauthorized reading of the proximity payment module or from other types of attacks against the system.

In some embodiments, an RF device may be secured to a shoe for purposes other than making or evidencing payment. For example, the RF device may be used to identify the wearer for the purpose of tracking the wearer around a race course in a foot race, or for detecting that the wearer is present in a retail store or in a specific location in a retail store. For the latter retail applications, user-specific (and possibly also location-specific) offers may be presented to the user upon detecting that he/she is present. In other retail applications, upon detecting the user's presence, store staff may be automatically informed to assemble, and/or deliver to the user, goods that the user had previously ordered by telephone or online.

In other applications, the user's location in his/her home may be tracked by the RF device in his/her shoe, and this knowledge of the user's location may be employed, e.g., to automatically turn on lights, etc. In safety applications, all employees in a facility may be tracked by RF devices in their shoes, e.g., for the purpose of facilitating evacuation in the event of an emergency.

In some embodiments, the user may have several shoe-installable RF devices, possibly for different purposes, and/or the RF devices may be physically transferable from one shoe to another.

Vehicular applications of the shoe-installed RF devices are also possible. For example, an RF reader may be installed near the gas or brake pedal of a motor vehicle for the purpose of reading the driver's identity from an RF device in the driver's shoe. In one application, the driver's identity is logged, e.g., to maintain a record of individuals who drive a bus or other public transit vehicle. In addition or alternatively, an interlock system in the vehicle may prevent the vehicle from being operated unless the driver is an authorized operator, as evidenced by identity information in the shoe-installed RF device. In addition or alternatively, when the vehicle detects the driver's identity, by reading the RF device in the user's shoe, the vehicle may configure itself to meet the driver's needs or preferences. For example, in response to reading the shoe-installed RF device, the vehicle may automatically adjust the positioning of the driver's seat and of rear view mirrors to pre-set positions suitable for the driver.

In still other applications, exercise equipment may include an RF reader positioned to read a user's shoe-installed RF device. Upon detecting the user's identity, the exercise equipment may configure itself to meet the user's preferences. As used herein and in the appended claims, a shoe may be said to incorporate a proximity payment device when the device is housed in, or securely affixed in or on, the shoe.

The above descriptions of processes herein should not be considered to imply a fixed order for performing the process steps. Rather, the process steps may be performed in any order that is practicable, including simultaneous performance of at least some steps.

Although the present invention has been described in connection with specific exemplary embodiments, it should be understood that various changes, substitutions, and alterations apparent to those skilled in the art can be made to the disclosed embodiments without departing from the spirit and scope of the invention as set forth in the appended claims.

What is claimed is:

1. A method comprising:
wearing a shoe on a user's foot, the shoe incorporating a proximity payment device; and
bringing the shoe into proximity with a proximity reader to make or evidence a payment.

2. The method of claim 1, wherein the shoe is brought into proximity with the proximity reader in connection with entering a transit system.

3. The method of claim 2, wherein the proximity reader is embedded in a floor at an entrance to the transit system.

4. The method of claim 1, wherein the proximity payment device stores a payment account number.

5. The method of claim 4, wherein the proximity payment device transmits the payment account number to the proximity reader.

6. The method of claim 5, wherein the proximity payment device transmits the payment account number to the proximity reader in encrypted form.

7. The method of claim 1, wherein the proximity payment device stores a payment token identifier.

8. The method of claim 7, wherein the proximity payment device transmits the payment token identifier to the proximity reader.

9. The method of claim 8, wherein the proximity payment device transmits the payment token identifier to the proximity reader in encrypted form.

10. The method of claim 1, further comprising:
bringing a personalization device into proximity with the shoe to load data from the personalization device into the proximity payment device.

11. The method of claim 10, wherein the loaded data includes a payment account number.

12. The method of claim 10, wherein the loaded data includes a payment token identifier.

13. The method of claim 1, wherein:
bringing the shoe into proximity with the proximity reader includes tapping a side of the shoe against a housing for the proximity reader.

14. The method of claim 13, wherein:
the tapping is performed in a substantially horizontal direction.

15. A method comprising:
defining an entrance to a transit system;
defining a path to said entrance; and
installing at least one proximity reader beneath said path, said at least one proximity reader for reading data from proximity payment devices worn by transit users.

16. The method of claim 15, wherein the proximity payment devices are worn in or on the user's shoes.

17. The method of claim 15, wherein the at least one proximity reader includes a plurality of proximity readers.

18. The method of claim 15, further comprising:
opening the entrance in response to reading the data from the proximity payment devices.

19. An apparatus comprising:
a floor;
a housing adjacent the floor and presenting a vertical surface joined to the floor and extending upwardly from the floor; and
a proximity reader mounted in the housing behind the vertical surface and adjacent a level of the floor.

20. The apparatus of claim 19, wherein the proximity reader is not more than 12 inches above the level of the floor.
